(19) United States
(12) Patent Application Publication
(10) Pub. No.: US 2005/0030388 A1
(43) Pub. Date: Feb. 10, 2005

(54) System and method for improving image capture ability

(76) Inventors: Donald J. Stavely, Windsor, CO (US); Amy E. Battles, Windsor, CO (US); Sarah J. Barrios, Fort Collins, CO (US); Kenneth R. Stockton, Fort Collins, CO (US); Kathy L. Miner, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/635,165

(22) Filed: Aug. 6, 2003

(51) Int. Cl. H04N 5/228

(52) U.S. Cl. 348/222.1

(57) ABSTRACT

According to one embodiment, a method is shown for improving image capturing ability, the method comprising electronically analyzing captured images to determine variations from accepted image criteria, electronically analyzing the determined variations to determine a pattern of determined variations, and providing an indication of relative image capturing performance.

### FIELD OF THE INVENTION

This invention relates to image capturing systems and more particularly to systems and methods for improving a user's image capture abilities.

### DESCRIPTION OF RELATED ART

One of the great advantages of digital photography is that the user can see the image in the camera's display, both before and after the exposure. Unfortunately, users continue making the same mistakes when capturing an image, resulting in amateurish and unsatisfying shots. Some of the most common mistakes are: dividing the image in half vertically with the horizon; centering the subject horizontally; making the shot too symmetrical; subject too far away; crooked horizon; no foreground framing; and back-lit scene.

Casual point-and-shoot photographers make these same mistakes over and over again. They are often unsatisfied with their photographic efforts, but do not know the techniques to improve their image capturing ability.

### BRIEF SUMMARY OF THE INVENTION

According to one embodiment, a method is shown for improving image capturing ability, the method comprising electronically analyzing captured images to determine variations from accepted image criteria, electronically analyzing the determined variations to determine a pattern of determined variations, and providing an indication of relative image capturing performance.

According to another embodiment, there is shown a system for providing image improvement assistance, the system comprising storage for storing captured images, analyzation capability for examining stored images against a set of image parameters, and reporting capability for providing image improvement assistance to a user based upon the analyzation of at least one stored image.

According to still a further embodiment there is shown a method of providing network accessible services, the method comprising, over a network common to a plurality of potential users, receiving at least one image from a user, comparing received ones of the images against image criteria, and providing image improvement suggestions to the user of the network, the suggestions based, at least in part, by the comparisons.

### BRIEF DESCRIPTION OF THE DRAWINGS

For a more complete understanding of the present invention, reference is now made to the following descriptions taken in conjunction with the accompanying drawing, in which:

FIG. 1 is a flow diagram of operation according to an embodiment;

FIG. 2 is a flow diagram of steps involved in analyzing an image in a teach or a fix mode according to an embodiment;

FIG. 3 is a flow diagram of an analysis module according to an embodiment; and

FIG. 4 is an embodiment of a computer system interfaced with a digital camera to provide a system embodiment for using the present method.

### DETAILED DESCRIPTION

In one embodiment, a software application grades a set of photos to identify common composition mistakes. The user is given feedback and suggestions for improvement. The system and method identify and troubleshoot common camera/user problems, and provide help to assist the user in correcting these problems in subsequent images.

In another embodiment, the system and method provide positive feedback on well-composed or well-executed images.

In still another embodiment, the application has a “teach mode” and a “fix mode”. The teach mode provides multiple layers or levels of instruction, while the fix mode provides one or more alternatives that the user can select, automatically correcting the image.

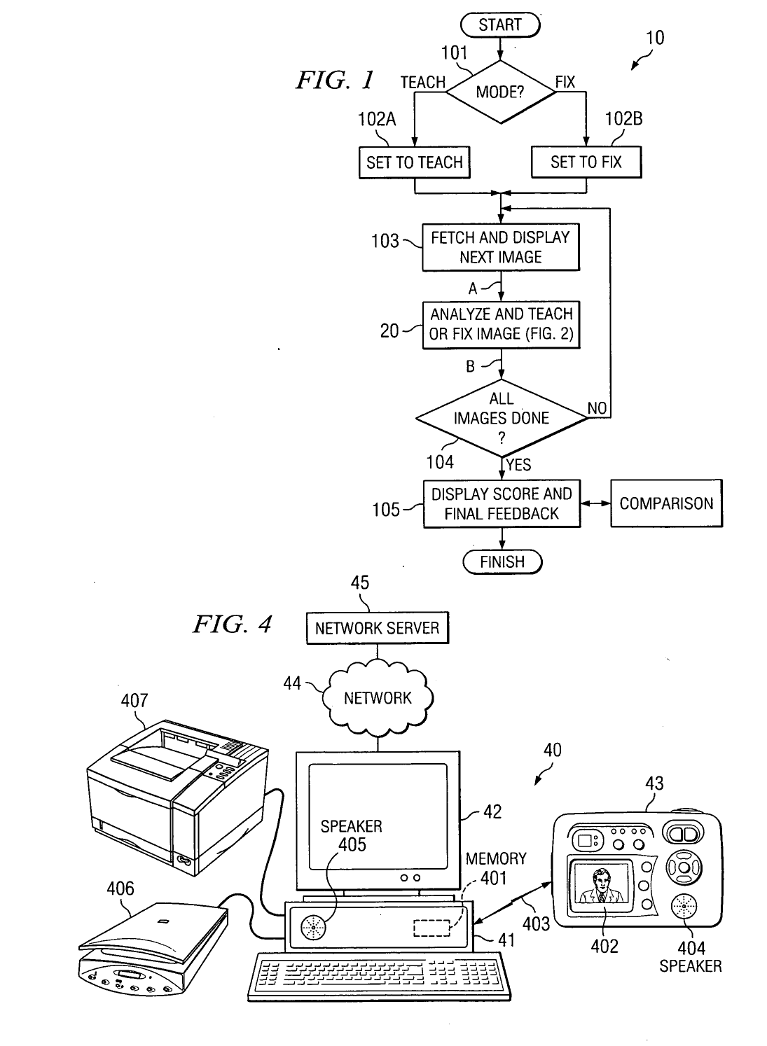

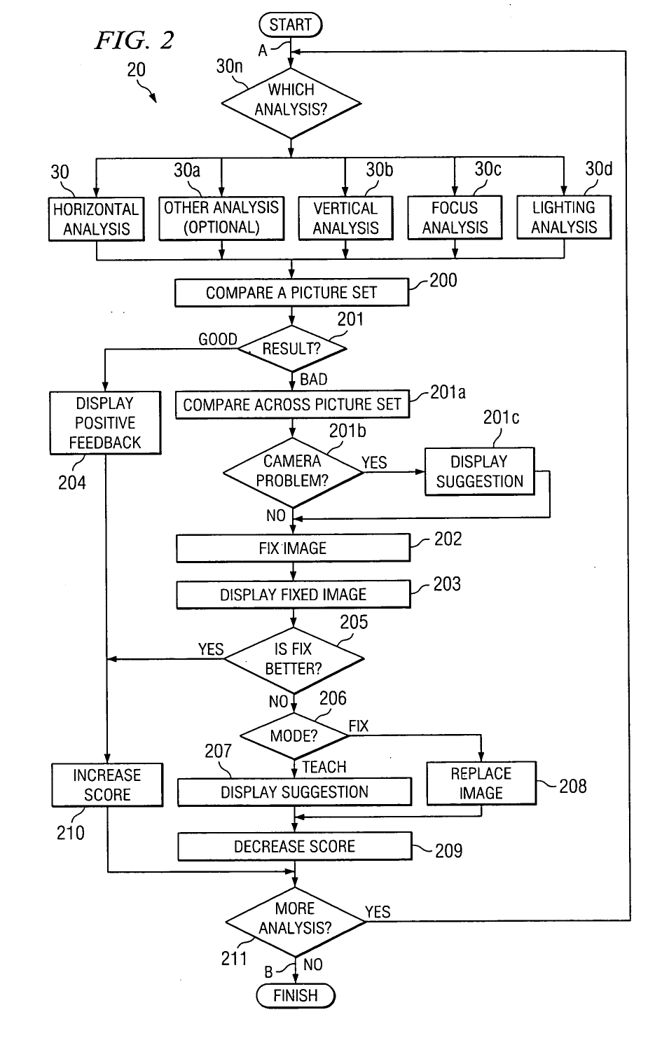

FIG. 1 shows flowchart 10 which is an overall view of operation according to an embodiment. Process 101 optionally establishes either teach mode 102A or fix mode 102B. In actual use, either or both modes may be used, if desired. Teach mode of the illustrated embodiment provides instruction to improve images and eliminate errors. Fix mode of the illustrated embodiment provides suggestions for the user to choose to improve the image, as well as actually correcting the mistakes. Either selection in the illustrated embodiment leads to the fetch and display next image process 103. Once the image is fetched and/or displayed, it is analyzed at process 20 with different results available for different modes. Point A, just before process 20, refers to FIG. 2 which provides a detailed description of steps in analyzing the image in process 20 according to the embodiment.

Point B, just after process 20, indicates a return from the processes of FIG. 2. After analysis, process 104 queries whether all images have been examined. This may be accomplished by comparison to a user input of the number of pictures, a user response to a question, a computer generated count of images, or by some other method of comparing the current image number to the total number of images. If the current image was not the last image to be examined, the system returns to process 103 to fetch and display the next image. When all images have been examined, the score and final feedback will be displayed audibly, visually, textually, or in some combination thereof by process 105. Final feedback may include comparing scores (grades) with previously saved scores to provide a comparison with previous attempts merely providing relative improvement data. Scores may also be dedicated to a particular user to provide a comparison between users and to personalize comparisons to each user.

The aforementioned scores may provide an indication of relative skill level and/or may provide details with respect to areas of strengths and/or weaknesses. For example, a score may indicate a user has generally properly framed subject but has not achieved proper lighting in many of the images. Additionally, or alternatively, a score may include a summary ranking, such as a letter, number, or title (e.g., professional, amateur, etc.) to provide a quick guide to a users current ability and/or progress.

It should be appreciated that the foregoing steps of FIG. 1 and associated feedback can be provided via a computer or a digital camera, or combinations thereof. For example, a digital camera may operate under control of an instruction set as described herein to provide real time guidance, instruction, correction, and/or feedback with respect to photos being taken by a camera user. Additionally, or alternatively, some or all of the foregoing may be implemented on a computer system for post photography processing. Such an embodiment might be desired in addition to a realtime camera embodiment to compile greater historical information and better guide a user in improving their photographic skills. Of course, a camera and computer may interact to facilitate improvement, such as by the computer determining a user's deficiencies and programming the camera to correct for some or all such deficiencies.

FIG. 2 shows flowchart 20, which is a detailed description of an embodiment of the steps involved in analyzing the image in teach or fix mode. Point A, at the start of the flowchart, refers to FIG. 1, just before process 20. FIG. 2 is a depiction of the processes that occurs in one embodiment of process 20. After being sent to process 20 of the illustrated embodiment, process 30n queries which analysis the user would like to invoke. In this example, horizontal analysis is the default setting. The horizontal analysis of process 30 and/or the other optional analysis of processes 30a, 30b, 30c, or 30d may be chosen. Optionally, the system can select one or more of these processes, such as based upon an internal analysis.

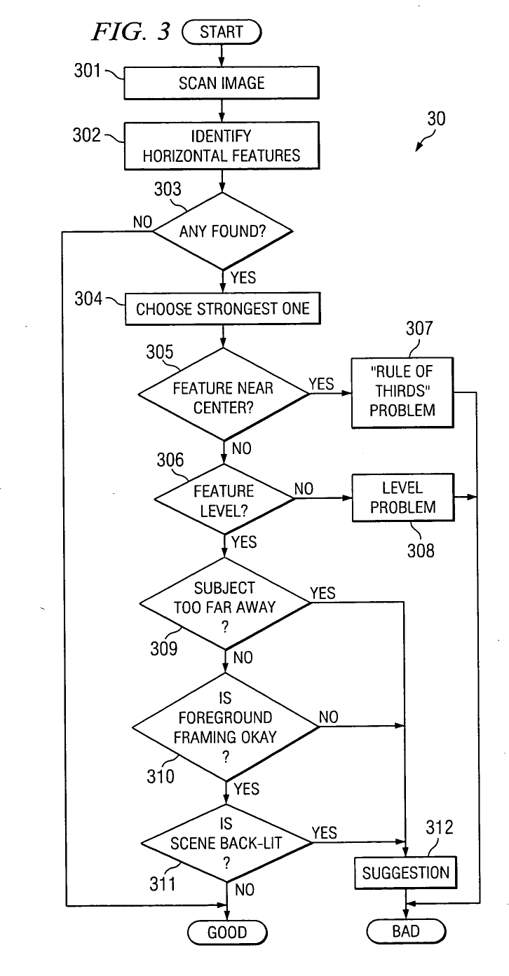

FIG. 3, which will be discussed hereinafter, further describes the steps of the horizontal analysis of process 30 to provide but one example of image processing as may be performed according to the present invention. Process 30a optionally performs one or more other analysis (for example, a red eye check by finding the eyes and testing the coloring found there for high levels of red coloration). Finding the eyes in the picture may be found by comparison to a database of pictures or by some other method that estimates the placement of the eyes. Process 30b performs optional vertical analysis. This may be accomplished by dividing the picture into some number of sections vertically and determining if there are dominant objects in each divided section. Process 30c performs optional focus analysis. This may be accomplished by comparing the spatial contrast of various regions in the scene to determine their sharpness. Process 30d performs optional lighting analysis. This may be accomplished by checking the intensity of the color levels in the image against a set range. These and additional optional analyses may also be performed with the addition of software modules that allow for greater analysis as the user gains expertise and chooses to add additional testing routines. For example, one or more analysis modules may be implemented in a host system, e.g., the aforementioned computer or digital camera, to provide desired and/or appropriate analysis. According to one embodiment, modules providing analysis with respect to common beginner or novice photographer errors may be initially supplied for use. Additional individual modules and/or combinations of modules may be subsequently added, such as to provide analysis appropriate to the advancing skills of the photographer, to analyze particular subject matter and/or artistic aspects of a photographer's pictures, to correspond to particular equipment and/or media (e.g., lenses, filters, film speed, etcetera), and the like. Various ones of the aforementioned modules may replace previous modules while other ones of the aforementioned modules may supplement modules already being utilized.

Returning now to FIG. 2, after initial analysis, process 200 checks across a picture set to determine a pattern of repetitive “errors.” For example, if a similar fault, (i.e., a violation of a rule) occurs in several pictures, it can be assumed that the user is not knowledgeable about the rule and this such repetitive pattern will be marked as a violation or error. Note that for different “rules” the tolerance for violations can be different, if desired. If there are no repetitive errors, or the number of errors have been reduced over previous picture sets, results query 201 is positive (good). If the result is good, positive feedback is provided audibly, visually, textually, or in some combination by process 204 through the computer or digital camera. The score is increased by process 210, and if no further analysis is to be conducted (process 211) processing proceeds to point B, at the end of the flowchart, returning to FIG. 1, just after process 20. Positive feedback may reference improvements in individual pictures and improvements in the overall score of a user or in a set of pictures.

Note that “errors” in the above context are variations from accepted criterion and the degree of variation that shows an error can be adjusted, if desired. Also note that variations from normal can be determined on a picture by picture basis, if desired.

If the result from the query at process 201 is bad, process 201a of the illustrated embodiment again compares across the picture set to check for camera problems that may be indicated by recurring problems over a set of pictures. Process 201b queries the result, and process 201c provides a suggestion audibly, visually, textually, or in some combination through the computer or digital camera for improvement of the camera problem if one has been found.

If no camera problem is found at 201b, or after the suggestion has been made for correction of one that is found at 201c, process 202 fixes the image under user control, and process 203 displays the fixed image. Process 205 next queries the user as to whether the fixed image is better. If the fixed image is better, the score is increased by process 210 and, if no further analysis is to be conducted, point B returns to FIG. 1, just after process 20. If the query at 205 finds that the fix is not better, the mode is queried by 206. Fix mode results in process 208 replacing the image with the “fixed” image and process 209 decreasing the score before point B returns to FIG. 1, just after process 20. Teach mode at process 206 causes a suggestion to be provided audibly, visually, textually, or in some combination through the computer or digital camera by process 207. Then the score is decreased by process 209.

Process 211 queries whether the user desires to perform additional analysis. If the user desires additional analysis, e.g., analysis as performed by any of processes 30a and 30d, the method of the illustrated embodiment returns to block 30n and repeats the method shown in FIG. 2 for that analysis. If the user does not desire additional analysis, the method continues to point B and returns to FIG. 1, just after process 20.

FIG. 3 shows flowchart 30, which depicts an embodiment of the horizontal analysis referenced by process 30 in FIG. 2. Although details with respect to horizontal analysis of process 30 are provided herein, it should be appreciated that image processing to provide additional, or alternative, image attribute analysis may be implemented by one of skill in the art, many using steps corresponding to those shown in FIG. 3.

In the embodiment illustrated in FIG. 3, an image is scanned by process 301 and the horizontal features are identified by process 302. The horizontal features are queried at process 303. If none are found, a “good” response of the horizontal analysis system is returned to process 201 of FIG. 2.

If horizontal features are found at process 303, process 304 chooses the strongest one. This may be accomplished by estimating the area of large objects and comparing them to find the largest object. Process 305 queries whether that feature is near the center. If the response to process 305 is yes, process 307 identifies a “rule of thirds” problem and returns a “bad” response from the horizontal analysis system. If the response to process 305 is no, process 306 queries whether the feature is level. This may be accomplished by comparing the height of a horizontal feature at each side of the image. If the feature is not level, process 308 identifies a level problem and a “bad” result is returned from the horizontal analysis system to process 201 of FIG. 2.

The rule of thirds is perhaps one of the most popular ‘rules’ in photography and yields pleasing compositions. The rule of thirds works by imaginary lines which divide the prospective image into thirds both horizontally and vertically. The most important elements of a composition are placed where these lines intersect. In addition to the intersections, the areas can be arranged into bands occupying a third of the image. Also, elements can be placed along the imaginary lines.

If the process 306 query responds that the feature is level, process 309 queries whether the subject is too far away. This may be accomplished by calculating the ratio of the area of the main feature to the area of the total image and comparing it to an acceptable ratio. If process 309 finds that the image is too far away, a suggestion is offered by process 312 and a “bad” response is returned from the horizontal analysis system to process 201 of FIG. 2. If the subject is not found to be too far away at 309, process 310 queries to see if the foreground framing is okay. This may be determined by checking a set frame of the image for dominant objects and determining the area of those objects to compare to an acceptable level. If there is a problem in the foreground framing, a suggestion is offered by process 312, and a “bad” response is returned from the horizontal analysis system to process 201 of FIG. 2. If there is no problem in the foreground framing, process 311 queries if the scene is back-lit. This may be checked by examining the relative brightness of dominant objects in the image. If the scene is back-lit, process 312 offers a suggestion and a “bad” response is returned from the horizontal analysis system to process 201 in FIG. 2. If process 311 finds that the scene is not back-lit, a “good” response is returned from the horizontal analysis system.

FIG. 4 depicts system 40, a computer set-up configured to implement an embodiment. A computer central processing unit 41, CPU, is connected to computer screen 42 for possible visual display of images, suggestions, or score comparisons. The CPU contains memory 401, for processing and storage of images and scores, and provides speaker 405 for optional audio output of suggestions and score comparisons. The computer may be connected to network 44, as may provide communication between processor based systems such as network server 45, to provide general access to the system or method throughout an office or between several computers. The printer 407 is coupled to computer 40 for output of data and images, such as output of suggestions and score comparisons and/or output of the images. The user may also scan images to digital format using scanner 406 (or any other imager) connected to the computer to provide an image with which to work without the use of a digital camera. The scanner image could be a picture, or even text, and the system described herein could be used to improve faulty images and to teach a user how to improve scanner images. The computer system may be interfaced with a digital camera 43 that contains screen 402 to view the images, instructions, suggestions, or score reports and may contain speaker 404 to hear audible instructions, suggestions, or score reports provided during the picture taking process. The entire method may also take place solely on the digital camera without interface to a computer or computer network. Also, it should be noted that the systems and methods discussed herein could apply to analog images as well as digital.

1. A method for improving image capturing ability, said method comprising:
electronically analyzing captured images to determine variations from accepted image criteria;
electronically analyzing said determined variations to determine a pattern of said determined variations; and
providing an indication of relative image capturing performance.

2. The method of claim 1 further comprising:
electronically fixing selected ones of said images based upon said electronic analyzation.

3. The method of claim 1 wherein said electronically comprises:
determining of at least one from the following group of image criteria: tilt from horizontal, violation of a rule of thirds, scene backlit, subject too far away, red eye analysis, vertical analysis, focus analysis, and lighting analysis.

4. The method of claim 1 wherein said electronically analyzing utilizes at least one module of a plurality of image criteria analysis modules.

5. The method of claim 4 wherein modules of said plurality of modules are independently added for use by said electronically analyzing.

6. The method of claim 1 further comprising the steps of providing suggestions for image improvement, said suggestions based upon said pattern of determined variations.

7. The method of claim 6 wherein said suggestions are provided by at least one of the following: visually, orally, textually.

8. The method of claim 1 wherein said pattern of determined variations is provided to a user.

9. The method of claim 8 wherein said provided pattern of variations is provided by at least one of the following: visually, orally, textually.

10. The method of claim 1 wherein at least one of said images is stored in a computer.

11. The method of claim 1 wherein said image capturing performance is a grade.

12. The method of claim 11 wherein said grades are stored for periods of time to determine relative improvement over said period of time.

13. The method of claim 1 further comprising:
electronically comparing a number of analyzed images to determine if a fault exists with the image capturing system.

14. The method of claim 1 wherein said method is stored on at least one of the following:
a network available to a plurality of users;
a PC for use by one or more users; and
a digital camera.

15. A system for providing image improvement assistance, said system comprising:
storage for storing captured images;
analyzation capability for examining stored images against a set of image parameters, and
reporting capability for providing image improvement assistance to a user based upon said analyzation of at least one stored image.

16. The system of claim 15 wherein said image improvement assistance includes suggestions with respect to at least one of the following:
tilt from horizontal, rule of thirds violations, image too close, image too far away, scene backlit, red eye analysis, vertical analysis, focus analysis, lighting analysis, imaging capture devise problems, and automatic image correction.

17. The system of claim 15 wherein said analyzation capability includes comparison of image groups.

18. A method of providing network accessible services, said method comprising:
receiving, over a network common to a plurality of potential users, at least one image from a user;
comparing received ones of said images against image criteria; and
providing image improvement suggestions to said user over said network, said suggestions based, at least in part, by said comparisons.

19. The method of claim 18 wherein said user images are generated by at least one of the following:
a camera; and
a scanner; and
wherein said improvement suggestions comprise at least one of the following:
praise for image improvement;
specific instructions for improving said image;
image capture device problems;
improvement grading; and
automatic correction of one or more of said images.

20. The method of claim 18 wherein said image improvement suggestions are based upon said comparison of a set of images to determine common patterns of image deviation from said image criteria.

21. A system for improving image capture ability, said system comprising:
means for storing captured images;
means for comparing a group of stored ones of said images against a set of criteria to determine faults; and
means for providing said fault information when said faults are repeated with respect to said group of stored images.

22. The system of claim 21 wherein said determined faults include at least one from the list of:
tilt from horizontal, rule of thirds violations, image too close, image too far away, scene backlit, red eye analysis, vertical analysis, focus analysis, lighting analysis, imaging capture devise problems, and automatic image correction.
